(19) United States
(12) Patent Application Publication
(10) Pub. No.: US 2013/0254691 A1
(43) Pub. Date: Sep. 26, 2013

(54) OPERATING A DEVICE WITH AN INTERACTIVE SCREEN, AND MOBILE DEVICE

(71) Applicant: International Business Machines Corporation, Armonk, NY (US)

(72) Inventors: Yan Chen, Beijing (CN); Bing Feng Han, Beijing (CN); Kuang Hu, Beijing (CN); Guo Jun Zhang, Beijing (CN)

(73) Assignee: INTERNATIONAL BUSINESS MACHINES CORPORATION, Armonk, NY (US)

(21) Appl. No.: 13/990,056

(22) PCT Filed: Nov. 29, 2011
(86) PCT No.: PCT/EP2011/071257

§ 371 Date: May 29, 2013

(30) Foreign Application Priority Data
Nov. 29, 2010 (CN) 201010577024.5

(51) Int. Cl. G06F 3/0484

(52) U.S. Cl. CPC G06F 3/04842
USPC 715/767

(57) ABSTRACT

Operating a device with an interactive screen includes determining a point on an interactive screen in response to an operable component on a device being operated, a location of the operable component on the device being independent from a location of the interactive screen on the device; locating a focus in content presented on the interactive screen based upon the point determined on the interactive screen; and highlighting the focus on the interactive screen for a user of the device to activate the focus by operating the interactive screen.

### CROSS-REFERENCE TO RELATED APPLICATIONS

This application is the national stage of PCT/EP2011/071257 filed Nov. 29, 2011, designating, inter alia, the United States and claiming priority to China Patent Application No. 201010577024.5 dated Nov. 29, 2010, each of which is incorporated herein by reference in its entirety.

### BACKGROUND

With the development of information technology, use of an interactive screen on a computing device has become increasingly popular. It is noted that the term “interactive screen” refers to a screen with which a user may directly interact using a particular tool (for example, a stylus, a finger, etc.) to thereby operate the device. One typical example of an interactive screen is a touch screen that a user may operate by touching the screen. Another example of an interactive screen is a proximity screen that a user may operate by placing an interactive tool proximate to the screen without actual touching of the screen. In contrast, a non-interactive screen refers to a screen that cannot be operated directly by the user, for example, a traditional cathode ray tube (CRT) or liquid crystal (LED) screen.

Compared to the operation mode of a non-interactive type screen in combination with other interactive tools (for example, a keyboard, a mouse, etc.), an interactive screen allows a user to directly operate the device in a more natural manner such as finger pointing, gesture, etc., which is thus prevalently attractive to consumers and providers. Moreover, with the proliferation of mobile computing technology, more and more mobile devices such as mobile phones, personal digital assistants (PDA), laptop computers, and tablet computers, have been equipped with an interactive screen.

Although the interactive screen has provided a more natural and straight forward operation mode to users, it suffers from its own operative drawbacks. For example, in order to ensure the convenience, mobility, and flexibility of computing, the miniaturization of computing devices has become a mainstream trend in the current field of information technology. Reduction in device size will inevitably result in reduction in size of the interactive screen equipped thereto. Reduction in screen size in turn results in increase of presentation density of content items on the screen. In this case, it is often difficult for a user to accurately locate a content item for a desired operation on the screen with a tool such as stylus or finger. Moreover, when the user operates the device in movement, it is more difficult to guarantee the accuracy of operation. In particular, such a problem is especially conspicuous in operation of a focus that is presented on an interactive screen.

It is noted that the term “focus” refers to a content item that a user may activate through interaction (for example, clicking) to trigger a particular event. For example, one typical example of a focus is a link contained in a web page. Clicking on a link on a page may trigger occurrence of web events such as page jump, data submission, etc. However, when the size of an interactive screen is relatively small and thereby results in a relatively high presentation density of links, it is hard for the user to accurately operate the desired link. Referring to FIG. 1A, an example of operating a web page with an interactive screen in the prior art is illustrated. In this example, when a user wants to click on a link with a finger, an operation error is very likely to occur because the presentation density of links is relatively high and the finger blocks more than one link during the operation. As a result, the clicked link is not the desired one.

Controls such as buttons, keys, selection boxes, and sliders on a web page or application interface are other kinds of examples of focuses. For example, referring to FIG. 1B, an example of operating a control with an interactive screen in the prior art is illustrated. In this example, a user wants to input information by clicking on or pressing a soft key presented on the interactive screen. Like FIG. 1A, since the presentation density of keys is relatively high and the finger blocks more than one key on the screen during the operation, it is hard for the user to guarantee the accuracy of operation.

Further, in the prior art, locating and activating a focus on the interactive screen are implemented in the same process. As previously mentioned, focuses usually have a relatively high density and will be blocked (for example, by a finger of the user) during the operation. Thus, locating and activating a focus in the same process will typically cause operation errors.

Apparently, the above drawbacks of a prior art interactive screen will have an adverse effect on users. For example, in the case that an operation error occurs, a user is at least required to re-perform one or more operations, which will inevitably lower use efficiency and dampen user experience. Moreover, in application scenarios such as financial transactions, securities transactions, information registration, and billing settlement, operation errors such as inputting information and/or clicking on a link incorrectly might cause losses, even unrecoverable serious consequences to users.

### BRIEF SUMMARY

One or more embodiments disclosed within this specification relate to operating a device with an interactive screen and/or a mobile device.

An embodiment includes a method for operating a device with an interactive screen. The method includes determining a point on the interactive screen in response to an operable component on the device being operated, a location of the operable component on the device being independent from a location of the interactive screen on the device. The method also includes locating, using a processor, a focus in content presented on the interactive screen based upon the point determined on the interactive screen and highlighting the focus on the interactive screen for a user of the device to activate the focus by operating the interactive screen.

Another embodiment includes an apparatus for operating a device with an interactive screen. The apparatus includes a screen point determining component configured to determine a point on the interactive screen in response to an operable component on the device being operated, a location of the operable component on the device being independent from a location of the interactive screen on the device. The apparatus further includes a focus locating component configured to locate a focus in content presented on the interactive screen based upon the point determined on the interactive screen, a display driving component configured to drive highlighting of the focus on the interactive screen, and a focus activating component configured to activate the focus in response to a user of the device operating the interactive screen.

Another embodiment can include a mobile device. The mobile device includes an interactive screen configured to present content and receive a request from a user of the mobile device for activating a presented focus. The mobile device also includes an operable component. A location of the operable component on the mobile device is independent from a location of the interactive screen on the mobile device.

### BRIEF DESCRIPTION OF THE SEVERAL VIEWS OF THE DRAWINGS

Through reading the following detailed description with reference to the accompanying drawings, the above and other objectives, features and advantages of the present invention will become more apparent. In the drawings, a plurality of embodiments of the present invention will be illustrated in an exemplary and non-limiting manner, wherein:

FIGS. 1A and 1B illustrate examples of operating a device with an interactive screen in the prior art;

FIG. 2 illustrates a diagram of a mobile device and an operable component according to an embodiment of the present invention;

FIG. 3 illustrates a flowchart of a method for operating a device with an interactive screen according to an embodiment of the present invention;

FIG. 4 illustrates a schematic view of an effect of highlighting a located focus according to an embodiment of the present invention;

FIG. 5 illustrates a block diagram of an apparatus for operating a device with an interactive screen according to an embodiment of the present invention; and

FIG. 6 illustrates a block diagram of a mobile device according to an embodiment of the present invention.

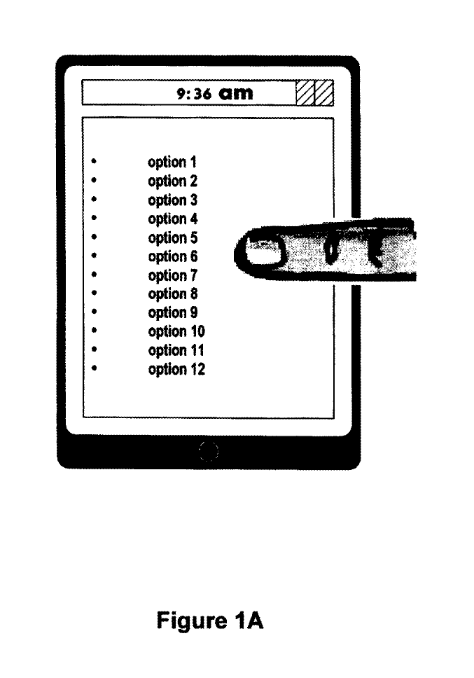

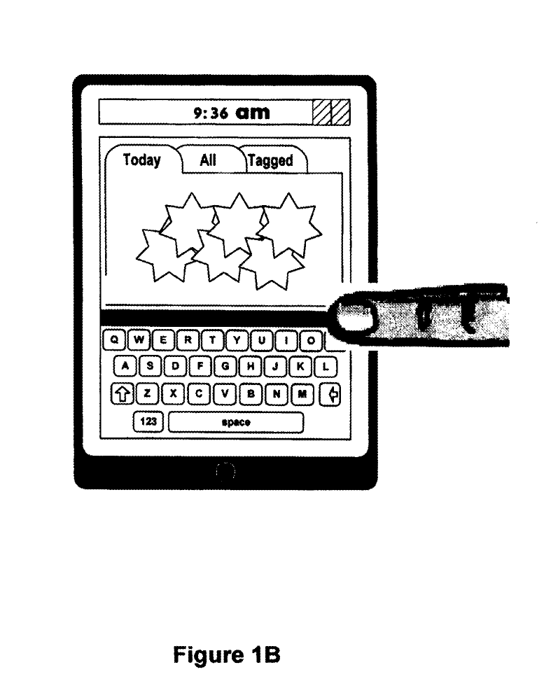

### DETAILED DESCRIPTION

Embodiments of the present invention relate to the field of information technology, and more particularly, to a method and apparatus for operating a device with an interactive screen, an apparatus, and a mobile device.

In order to overcome the above problems in the prior art, it is desirable in this field to provide a method and apparatus for operating a device with an interactive screen more accurately and efficiently. Therefore, the embodiments of the present invention propose a method and apparatus for operating a device with an interactive screen, and a corresponding mobile device.

In an embodiment, there is provided a method for operating a device with an interactive screen. The method comprises: determining a point on the interactive screen in response to an operable component on the device being operated, a location of the operable component on the device being independent from a location of the interactive screen on the device; locating a focus in content presented on the interactive screen based upon the point determined on the interactive screen; and highlighting the focus on the interactive screen for a user of the device to activate the focus by operating the interactive screen.

In another embodiment, there is provided an apparatus for operating a device with an interactive screen. The apparatus comprises: a screen point determining component configured to determine a point on the interactive screen in response to an operable component on the device being operated, a location of the operable component on the device being independent from a location of the interactive screen on the device; a focus locating component configured to locate a focus in content presented on the interactive screen based upon the point determined on the interactive screen; a display driving component configured to drive highlighting of the focus on the interactive screen; and a focus activating component configured to activate the focus in response to a user of the device operating the interactive screen.

In a further embodiment, there is provided a mobile device. The device comprises: an interactive screen configured to present content and receive a request from a user of the mobile device for activating a presented focus; and an operable component, a location of the operable component on the mobile device being independent from a location of the interactive screen on the mobile device; and an apparatus as above mentioned.

According to embodiments of the present invention, locating and activating a focus on an interactive screen are decomposed into two separate processes. When a user attempts to activate a particular focus on the interactive screen, he/she is allowed to first use an operable component outside the interactive screen to locate this focus, thereby effectively avoiding blocking the focus during the operation. Moreover, according to embodiments of the present invention, during the process of locating a focus, the located focus will be highlighted to provide the user with a real-time and intuitive feedback, such that the user may clearly know whether a desired focus is located. After the desired focus is located, the user may conveniently activate the focus in a plurality of manners. Therefore, based upon embodiments of the present invention, accuracy and efficiency of operating the device with an interactive screen may be effectively improved, and the probability of operation errors may be significantly reduced, such that the user experience is improved.

Embodiments of the present invention relate to a method, apparatus, and device for operating a device with an interactive screen. A plurality of embodiments of the present invention will be described below in an exemplary manner with reference to the accompanying drawings. It should be noted that the embodiments as illustrated and described hereinafter are only for illustrating the principles of the present invention, and are not intended for limiting the scope of the present invention. The scope of the present invention is only limited by the appended claims.

In one embodiment of the present invention, operations on a focus when using a device with an interactive screen are decomposed into two separate processes: locating a focus and activating the focus. During the process of locating a focus, in order to prevent a user's finger from blocking a focus presented on an interactive screen, the user is allowed to locate the focus by means of a particular operable component on an operating device, a location of the operable component on the device being independent from a location of the interactive screen on the device. When the user locates the desired focus using the operable component, the user may use various kinds of convenient approaches to activate the focus.

In one embodiment, an operable component independent from the interactive screen (for example, outside the interactive screen) is used to locate the focus. In certain embodiments, the operable component and interactive screen may be exposed on different faces or sides of the device. For example, supposing the face on which the interactive screen is exposed is a front face of the device, the operable component may be exposed on a back face and/or side face of the device. In other embodiments, the operable component may be exposed on the same side as the interactive screen but external to it. According to an embodiment of the present invention, the operable component may comprise a touch pad (capacitive, inductive or any other suitable touch pad), TrackPoint, and/or any currently known or future developed appropriate operable component.

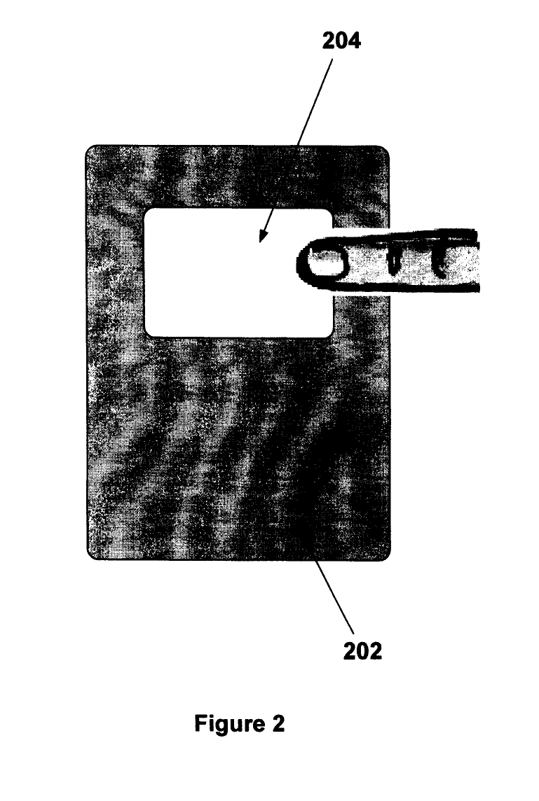

For example, referring to FIG. 2, a rear view of a mobile device according to an embodiment of the present invention is illustrated. In the example of FIG. 2, a device 202 has an interactive screen (not illustrated) exposed on the front face, and an operable component 204 exposed on the back face. It may be seen that in this example, the operable component 204 is implemented as a touch pad located on a different face of the device 202 from the interactive screen. It should be noted that the embodiment of FIG. 2 is merely exemplary, and other operable components and arrangements thereof are also possible. The present invention is not limited in this aspect.

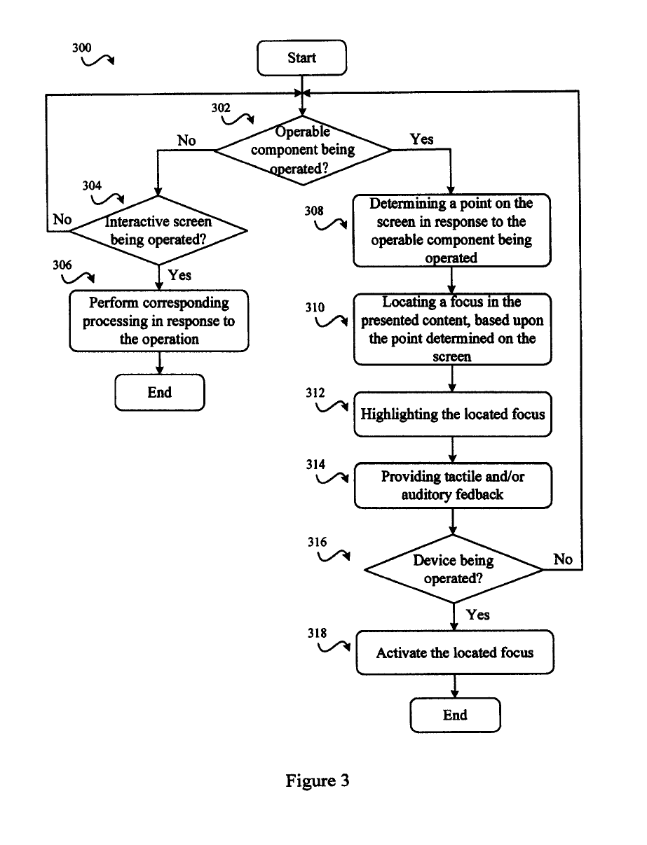

Referring to FIG. 3, a method 300 for operating a device with an interactive screen according to an embodiment of the present invention is illustrated. After start of the method 300, at step 302, whether an operable component on the device is operated is determined. If the operable component is not operated (branch “No”), then the method 300 proceeds to step 304 where it is determined whether the interactive screen is operated by the user. If the interactive screen is operated by the user (branch “Yes”), then the method 300 proceeds to step 306 where corresponding processing is performed in response to the operation. If it is determined at step 304 that the interactive screen is not operated (branch “No”), then the method 300 returns to step 302 to further determine whether the operable component is operated by the user.

On the other hand, at step 302, if it is determined that the operable component is operated (branch “Yes”), then the method 300 proceeds to step 308 where a point on the interactive screen is determined in response to the operation of the operable component. According to an embodiment of the present invention, operation of step 308 may be performed by any proper technology that is currently known or to be developed in future. For example, in an embodiment where a touch pad is used as an operable component (for example, as illustrated in FIG. 2), a current location on the touch pad where the interactive tool such as a finger of the user or a stylus comes into contact may be first obtained. Since the size of the touch pad and the size of the interactive screen are known, based upon the relationship between these two sizes, the location on the touch pad may be then converted by a coordinate transformation to a particular location on the screen, i.e., a point on the screen. For another example, in an embodiment where a TrackPoint is used as an operable component, when a user pushes to move the TrackPoint with a finger, a substrate of the TrackPoint will generate different deformations in various directions in response to the strength of the push force, such that a sensor arranged surrounding the TrackPoint will generate different voltages due to compression or expansion. In this way, the device may obtain the strength and direction of the forces applied to the TrackPoint, and thereby a coordinate of a corresponding point on the interactive screen may be determined.

Next, at step 310, a focus in the displayed content is located based upon the point on the screen as determined at step 308. To this end, location information of all focuses as currently presented on the screen is first obtained. Then, a particular focus is located by comparing a location of the focuses and the location of the screen point determined at step 308. This process will be described in detail in the following.

Location information of all focuses presented on a screen may be obtained through any suitable technology that is currently known or to be developed in future. For example, according to an embodiment of the present invention, when a source file of the content presented on the screen is of an Extensible Markup Language (XML), as known in the art, the device will generate a corresponding document structure model (DOM) when presenting this content. The DOM records locations of respective elements on the screen as currently presented in a manner of, for example, tree structure (e.g., in a form of coordinate values). In this case, information about all focuses on the screen may be obtained by accessing the DOM of the source file of the content. As a specific example, when a Web page written in a Hypertext Markup Language (HTML) is presented on the interactive screen, coordinates of all displayable elements contained in the Web page on the screen may be obtained by accessing and retrieving the DOM of the Web page, thereby obtaining accurate locations of focuses such as links and keys.

Alternatively or additionally, in an embodiment of the present invention, location information of focuses on the screen may also be obtained by an operating system or other basic supporting system. For example, most operating systems are provided with an application programming interface (API) for determining locations of each and every focus on a current user interface (UI). In this event, location information of focuses on the screen may be obtained by calling a suitable API.

After obtaining the locations of the focuses, a focus may be located by comparing the locations of the focuses with that of the screen point determined at step 308. It may be understood that in practice, when the user desires to operate a focus, he/she can activate only one focus each time. This is determined by the characteristic of the focus itself, because activating two or more focuses at the same time will cause confusion of event triggering, which is not allowed. Therefore, according to embodiments of the present invention, a single focus is always located at step 310.

In particular, at step 310, a focus that is closest to the location of the screen point determined at step 308, i.e., a focus with the minimal distance, may be located. When more than one focus has an equal distance to the screen point as determined, a single focus may be located according to various kinds of policies. For example, in some embodiments, a focus may be randomly selected from all focuses equidistant from the screen point as determined. In other embodiments, using a prediction method (for example, heuristic method, statistical model method, etc.), a focus that is most likely to be operated at present may be predicted from these equidistant focuses based upon previous operations of the user. Further, in some embodiments, where more than one focus is equidistant from the screen point as determined, it is also possible to locate no focus, but to wait for continued operation of the user to the operable component until only a single focus is closest to the screen point as determined. It should be noted that the above policies are only exemplary, and other policies/standards are also feasible. The present invention is not limited to this aspect.

Next, at step 312, the focus located at step 310 is highlighted on the interactive screen. According to an embodiment of the present invention, the focus may be highlighted in various suitable manners, including but not limited to resizing of the focus (e.g., zooming in scaling up), changing the color of the focus, changing the font of the focus (for example, italicized, underlined, and bold, etc.), and among others. Additionally, according to an embodiment of the present invention, appearance of the focus may be changed by using various kinds of visual effects (for example, magnifier, embossment, depressed, lighting, etc.) and/or animation effect so as to implement the highlighting of focus.

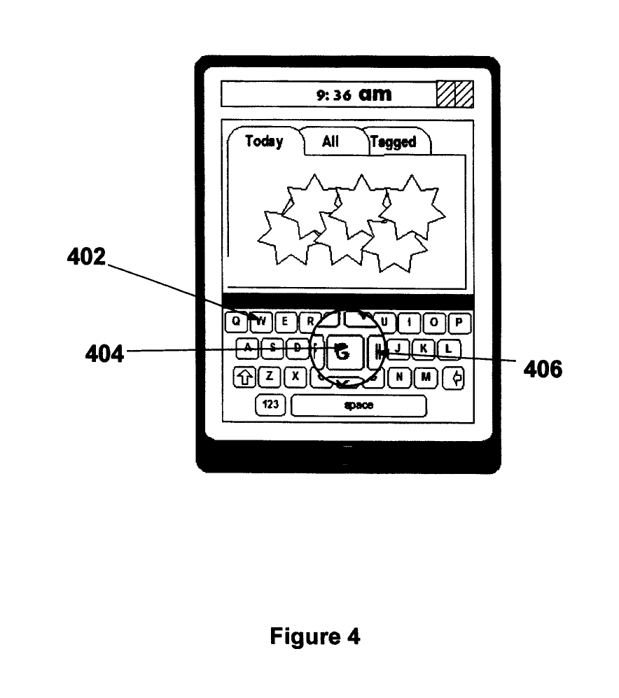

As an example of a display effect of step 312, reference is made to FIG. 4 in which a schematic view of an effect of highlighting the located focus according to an embodiment of the present invention is illustrated. As illustrated, reference number 402 in FIG. 4 indicates a focus which is not highlighted, i.e., a focus not located at step 310. This focus is still presented in a conventional manner. Reference number 404 indicates the focus which is determined at step 310 and is highlighted at step 312. It may be seen that in the example as illustrated in FIG. 4, the located focus is highlighted by a visual effect of “magnifier” or fish eye and a change in color. In an embodiment, the content surrounding the highlighted focus is also displayed with corresponding deformation, such as the letter keys “F” and “H” at two sides of the letter key “G” as illustrated in FIG. 4.

In particular, as mentioned above, in an embodiment, only a single focus is located each time so as to guarantee that the user is then able to correctly activate the focus. Thus, as illustrated in FIG. 4, though the focus indicated by reference number 406 is very close to the focus 404 (and therefore also located in the range of “magnifier”), it is not located and highlighted (its color does not change, but the content surrounding the focus may also be displayed with deformation so as to increase the vitality). In this way, in the subsequent operation, the user is allowed to accurately and conveniently activate the focus 404, which will be detailed below. It is noted that the above depiction and the highlighting manner as illustrated in FIG. 4 are merely exemplary, and other highlighting manners are possible as well. The present invention is not limited in this regard.

Returning to FIG. 3, at step 314, in response to the focus being located and highlighted, a feedback may be provided to the user so as to enhance user experience. In some embodiments, feedback may comprise auditory feedback. For example, while highlighting the focus, a predetermined audio is played by an audio output means of the device. Alternatively or additionally, feedback may comprise tactile feedback. For example, while highlighting the focus, the device is enabled to generate vibration. Further, feedback may be user configurable. In other words, the user may choose to enable/disable feedback, and/or may set various parameters regarding feedback, such as audio source for playing, volume, vibration times, vibration frequencies, etc.

Then, at step 316, it is determined whether the user performs a particular operation to the device in a state that the particular focus is located and highlighted. If the user does not perform a particular operation to the device (branch “No”), it might indicate that the currently located and highlighted focus is not the focus that the user wants to operate. In this case, the method 300 proceeds to step 302 such that the user is able to locate another focus by continuing operating the operable component. On the other hand, if it is determined at step 316 that the user performs the particular operation to the device in a state that the focus is highlighted (branch “Yes”), the method proceeds to step 318 where the located focus is activated. The method 300 ends accordingly.

Please note that at step 316, the particular operation used for activating the focus may comprise various operations to the device. In some embodiments, the user of the device may activate a focus by operating the interactive screen. For example, when the user locates a desired focus with an operable component independent from the screen, he/she may click the focus on the interactive screen to thereby activate the focus. In particular, in embodiments of the present invention, since only a single focus can be located each time, the user may activate a focus as currently highlighted through clicking on an arbitrary location of the interactive screen, without necessarily accurately clicking on the focus per se. Apparently, it is possible to significantly reduce user burden and improve operation accuracy, especially in a mobile use environment.

In other embodiments, the user may also activate the focus by operating the operable component. For example, after locating a desired focus, the user may further activate the focus by operating the operable component in a manner of pressing, clicking, and/or in other predetermined manner. In still further embodiments, the user may activate the focus by operating other components (for example, buttons, keys, joystick, etc.) in addition to the interactive screen and operable component on the device. It may be understood that the particular operation for activating the focus is user configurable.

It may be understood that according to the method of the embodiments of the present invention, the user may perform the processes of locating and activating a focus by collaboration of two hands, or perform these two processes with one hand, which may be determined flexibly by the user based upon factors such as his/her operation habits and application environment.

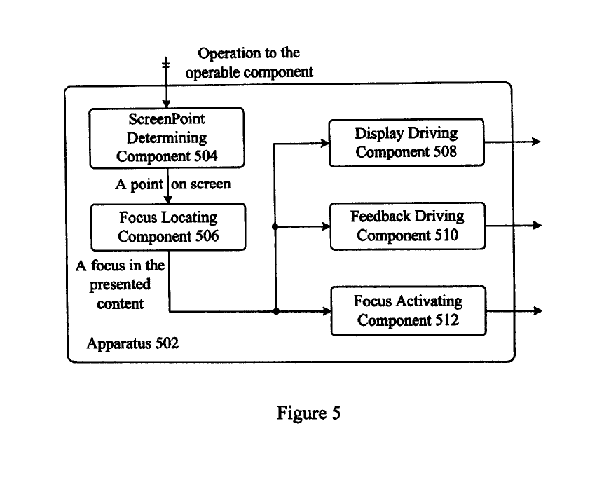

Now referring to FIG. 5, a block diagram of an apparatus 502 for operating a device with an interactive screen according to an embodiment of the present invention is illustrated. It is noted that the apparatus 502 may be implemented with software, and components 504-512 are correspondingly implemented by software modules. The apparatus 502 may also be implemented by hardware and/or firmware such as a dedicated integrated circuit (ASIC), a universal integrated circuit, and a system-on-chip (SOC), etc. Dependent on its specific implementation, the apparatus 502 may reside in/on a target device to be operated in various suitable manners.

As illustrated in the figure, the apparatus 502 comprises a screen point determining component 504 configured to determine a point on an interactive screen of a device in response to an operable component on the device being operated. As previously discussed, this operable component may be at least one of the touch pad and TrackPoint, and its location on the device is independent from the location of the interactive screen on the device. According to embodiments of the present invention, the operable component and the interactive screen are exposed on a same face or different faces of the device. How to determine a point on the screen based upon an operation to the operable component has been described above with reference to FIG. 3, which will not be detailed here.

The apparatus 502 further comprises a focus locating component 506 configured to locate a focus in content presented on the interactive screen based upon the point as determined on the screen by the screen point determining assembly 504. How to locate a focus based upon the screen point as determined has been described above with reference to FIG. 3, which will not be detailed here.

The focus locating component 506 may be further configured to pass the currently located focus to a display driving component 508. The display driving component 508 may be configured to drive the highlighting of the located focus on the interactive screen, for example, resizing the focus, changing the color of the focus, and changing the font of the focus, etc. In some embodiments, the apparatus 502 may further comprise a feedback driving component configured to drive the device to provide tactile and/or auditory feedback to the user in response to locating a focus. For example, the feedback driving component may issue an instruction to a relevant means of the device such that it generates a tactile and/or auditory output.

Moreover, according to embodiments of the present invention, the apparatus 502 comprises a focus activating component 512 configured to activate a currently located and highlighted focus in response to the user of the device operating the interactive screen. In addition, the focus activating component 512 is further configured to activate the focus in response to the device user operating the operable component or any other component of the device.

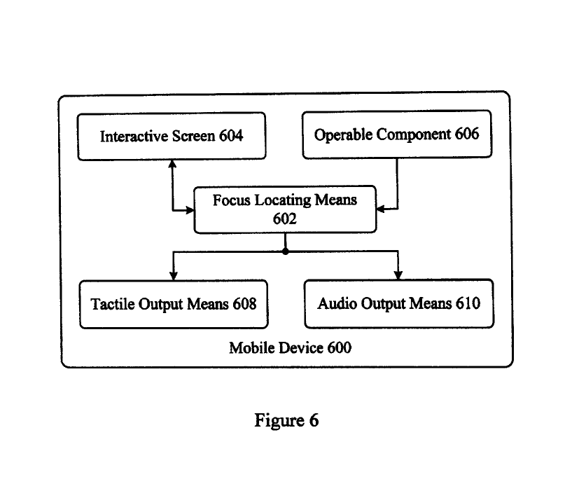

FIG. 6 illustrates a block diagram of a device 600 according to an embodiment of the present invention. According to embodiments of the present invention, the device 600 may be a mobile device with an interactive screen, for example, a mobile phone, a PDA, a laptop computer, etc. Although described as a mobile device in the present invention, it can be understood that the device 600 may also be a fixed computing device equipped with an interactive screen.

As illustrated, according to embodiments of the present invention, the mobile device 600 comprises: a focus locating means 602; an interactive screen 604; and an operable component 606. The interactive screen 604 is configured to present content and receive a request from a user of the mobile device for activating a presented focus. A location of the operable component 606 on the mobile device 600 is independent of a location of the interactive screen 604 on the mobile device 600. The user may use the operable component 606 to locate a focus desired to operate. The focus locating means 602 is configured to locate and highlight a particular focus based upon a user's operation to the operable component 606. The structure and operation of the means 602 exactly correspond to the apparatus 502 as depicted above with reference to FIG. 5, which will not be detailed here.

As illustrated in FIG. 6, in some embodiments, the mobile device 600 may further comprise a tactile output means 608 configured to provide tactile feedback to the user based upon an instruction from the means 602 (specifically, a feedback driving component). For example, the tactile output means 608 may be, for example, a vibration means which is operable to enable the mobile device 600 to generate vibration. Alternatively or additionally, in some embodiments, the mobile device 600 may further comprise an audio output means 610 configured to provide auditory feedback to the user based upon an instruction from the means 602 (specifically, a feedback drive component). As above mentioned with reference to FIG. 3, in some embodiments, enable/disable of the tactile output means 608 and audio output means 610 and relevant parameters are user configurable.

The method, apparatus and device according to various embodiments of the present invention have been described with respect to a plurality of exemplary embodiments. It may be understood that according to embodiments of the present invention, locating and activating a focus on an interactive screen are decomposed into two separate processes. When a user attempts to activate a particular focus on an interactive screen, he/she may locate the focus with an operable component located outside the interactive screen type screen. According to embodiments of the present invention, during the process of locating a focus, a real-time and intuitive feedback is provided to the user by highlighting the current located focus. After confirming that the desired focus is located, the user may conveniently activate the focus in a plurality of manners. In embodiments of the present invention, the user may exactly locate a single desired focus without blocking the screen, even though the focus presentation density on the screen is high. Therefore, embodiments of the present invention may effectively improve the accuracy and efficiency of operating a device with an interactive screen and significantly reduce the probability of operation errors, thereby improving user experience.

It is noted that, each block in the flowcharts or block may represent a module, a program segment, or a part of code, which contains one or more executable instructions for performing specified logic functions. It should be further noted that, in some alternative implementations, the functions noted in the blocks may also occur in a sequence different from what is noted in the drawings. For example, two blocks illustrated consecutively may be performed in parallel substantially or in an inverse order. It should also be noted that each block in the block diagrams and/or flow charts and a combination of blocks in block diagrams and/or flow charts may be implemented by a dedicated hardware-based system for executing a prescribed function or operation or may be implemented by a combination of dedicated hardware and computer instructions.

The method and apparatus according to embodiments of the present invention may employ a form of complete hardware embodiments, complete software embodiments, or both. In a preferred embodiment, the present invention is implemented as software, including, without limitation to, firmware, resident software, micro-code, etc.

Moreover, the present invention may be implemented as a computer program product usable from computers or accessible by computer-readable media that provide program code for use by or in connection with a computer or any instruction executing system. For the purpose of description, a computer-usable or computer-readable medium may be any tangible means that can contain, store, communicate, propagate, or transport the program for use by or in connection with an instruction execution system, apparatus, or device.

The medium may be an electric, magnetic, optical, electromagnetic, infrared, or semiconductor system (apparatus or device), or propagation medium. Examples of the computer-readable medium would include the following: a semiconductor or solid storage device, a magnetic tape, a portable computer diskette, a random access memory (RAM), a read-only memory (ROM), a hard disk, and an optical disk. Examples of the current optical disk include a compact disk read-only memory (CD-ROM), compact disk-read/write (CR-ROM), and DVD.

A data processing system adapted for storing or executing program code would include at least one processor that is coupled to a memory element directly or via a system bus. The memory element may include a local memory usable during actually executing the program code, a mass memory, and a cache that provides temporary storage for at least one portion of program code so as to decrease the number of times for retrieving code from the mass memory during execution.

An Input/Output or I/O device (including, without limitation to, a keyboard, a display, a pointing device, etc.) may be coupled to the system directly or via an intermediate I/O controller.

A network adapter may also be coupled to the system such that the data processing system can be coupled to other data processing systems, remote printers or storage devices via an intermediate private or public network. A modem, a cable modem, and an Ethernet card are merely examples of a currently usable network adapter.

Although a plurality of embodiments of the present invention have been described above, those skilled in the art should understand that these depictions are only exemplary and illustrative. Based upon the teachings and inspirations from the specification, modifications and alterations may be made to the respective embodiments of the present invention without departing from the true spirit of the present invention. Thus, the features in the specification should not be regarded as limiting. The scope of the present invention is only limited by the appended claims.

1. A method for operating a device with an interactive screen, comprising:
determining a point on the interactive screen in response to an operable component on the device being operated, a location of the operable component on the device being independent from a location of the interactive screen on the device;
locating, using a processor, a focus in content presented on the interactive screen based upon the point determined on the interactive screen; and
highlighting the focus on the interactive screen for a user of the device to activate the focus by operating the interactive screen.

2. The method according to claim 1, wherein the operable component is at least one of a touch pad or a TrackPoint.

3. The method according to claim 1, wherein the operable component and the interactive screen are exposed on a same face or different faces of the device.

4. The method according to claim 1, wherein highlighting the focus comprises at least one of: resizing the focus, changing a color of the focus, or changing a font of the focus.

5. The method according to claim 1, further comprising:
providing at least one of tactile or auditory feedback in response to locating the focus.

6. The method according to claim 1, wherein a source file of the content is of an extensible markup language (XML) format, and locating the focus comprises:
accessing a document object model (DOM) of the source file of the content.

7. The method according to claim 1, wherein the device is a mobile device.

8. The method according to claim 1, wherein the interactive screen is a touch screen or a proximity screen.

9. An apparatus for operating a device with an interactive screen, comprising:
a screen point determining component configured to determine a point on the interactive screen in response to an operable component on the device being operated, a location of the operable component on the device being independent from a location of the interactive screen on the device;
a focus locating component configured to locate a focus in content presented on the interactive screen based upon the point determined on the interactive screen;
a display driving component configured to drive highlighting of the focus on the interactive screen; and
a focus activating component configured to activate the focus in response to a user of the device operating the interactive screen.

10. The apparatus according to claim 9, wherein the operable component is at least one of a touch pad or a TrackPoint.

11. The apparatus according to claim 9, wherein the operable component and the interactive screen are exposed on a same face or different faces of the device.

12. The apparatus according to claim 9, wherein highlighting the focus comprises at least one of: resizing the focus, changing a color of the focus, or changing a font of the focus.

13. The apparatus according to claim 9, further comprising:
a feedback driving component configured to drive the device to provide at least one of tactile or auditory feedback in response to locating the focus.

14. The apparatus according to claim 9, wherein a source code of the content is of an extensible markup language (XML) format, and locating the focus comprises:
accessing a document object model (DOM) of the source code of the content.

15. The apparatus according to claim 9, wherein the device is a mobile device.

16. The apparatus according to claim 9, wherein the interactive screen is a touch screen or a proximity screen.

17. A mobile device comprising:
an interactive screen configured to present content and receive a request from a user of the mobile device for activating a presented focus; and
an operable component, a location of the operable component on the mobile device being independent from a location of the interactive screen on the mobile device.

18. The mobile device according to claim 17, further comprising:
a tactile output means configured to provide tactile feedback based upon an instruction from the feedback driving component.

19. The mobile device according to claim 17, further comprising:
an audio output means configured to provide auditory feedback based upon an instruction from the feedback driving component.
